(19) United States
(12) Patent Application Publication
(10) Pub. No.: US 2024/0192811 A1
(43) Pub. Date: Jun. 13, 2024

(54) Systems With Deformable Controllers

(71) Applicant: Apple Inc., Cupertino, CA (US)

(72) Inventors: Muhammad F. Hossain, Santa Clara, CA (US); Samuel A. Resnick, San Francisco, CA (US)

(21) Appl. No.: 18/425,210

(22) Filed: Jan. 29, 2024

Related U.S. Application Data
(63) Continuation of application No. PCT/US22/39275, filed on Aug. 3, 2022.
(60) Provisional application No. 63/229,843, filed on Aug. 5, 2021.

(51) Int. Cl. G06F 3/044; G06F 3/03; G06F 3/0346

(52) U.S. Cl. CPC G06F 3/044; G06F 3/0304; G06F 3/0346; G06F 2203/04102; G06F 2203/04104

(57) ABSTRACT

A controller may be provided for use with electronic equipment. The electronic equipment may include a head-mounted device that uses user input to control displayed images, a computer stylus or other accessory, a handheld device such as a remote control, and/or other electronic devices. The controller may have a nub-shaped housing. The housing may be formed from a flexible housing wall that has an elongated dome shape extending along an axis. User finger input may be provided to the controller during operation. Sensor circuitry in the flexible housing may be used in detecting user finger input such as multitouch touch input, force input in which a user's finger presses against the flexible housing, and deformation input in which the flexible housing is bent away from the axis or otherwise deformed by a user's finger.

This application is a continuation of international patent application No. PCT/US2022/039275, filed Aug. 3, 2022, which claims priority to U.S. provisional patent application No. 63/229,843, filed Aug. 5, 2021, which are hereby incorporated by reference herein in their entireties.

### FIELD

This relates generally to electronic devices, and, more particularly, to devices with controllers.

### BACKGROUND

Electronic devices such as head-mounted devices and other devices may present images and other content to users. Input-output devices such as computer mice, trackpads, and other controllers are used to control displayed objects and otherwise interact with this content.

### SUMMARY

A controller may be provided for use with an electronic device. The electronic device may be a head-mounted device that gathers user input and that controls visual content based on the user input, may be a computer stylus or other accessory, may be a handheld device such as a remote control, and/or may be other electronic equipment. The controller may be mounted on a head-mounted housing or other electronic device housing. A user may provide input to the controller with one or more fingers. The input may be sensed using sensing circuitry in the controller.

The controller may have a nub-shaped housing with an elongated dome shape that extends along an axis. The housing may be formed from a flexible housing structure that allows the housing to be deformed. User finger input may be provided to the controller during operation.

Sensor circuitry in the flexible housing may be used in detecting user finger input such as multitouch touch input (e.g., pinch input, twisting input, sliding gestures, tap input, etc.), force input in which a user's finger presses against the flexible housing, and/or deformation input in which the flexible housing is bent away from the axis or otherwise deformed by a user's finger.

### BRIEF DESCRIPTION OF THE DRAWINGS

FIG. 1 is a schematic diagram of an illustrative system in accordance with an embodiment.

FIG. 2 is a perspective view of an illustrative computer-generated three-dimensional environment in accordance with an embodiment.

FIG. 3 is a side view of an illustrative device with a controller in accordance with an embodiment.

FIG. 4 is a perspective view of an illustrative handheld electronic device with a controller in accordance with an embodiment.

FIG. 5 is a top view of an illustrative head-mounted device with a controller in accordance with an embodiment.

FIGS. 6, 7, 8, 9, and 10 are side views of an illustrative deformable controller being used to gather user input from a user's fingers in accordance with an embodiment.

FIG. 11 is a cross-sectional side view of an illustrative deformable controller in accordance with an embodiment.

FIG. 12 is a cross-sectional side view of an illustrative deformable controller with capacitive sensor electrodes in accordance with an embodiment.

FIG. 13 is a top view of an illustrative strain gauge in accordance with an embodiment.

FIG. 14 is a side view of an illustrative deformable controller with sensor circuitry in accordance with an embodiment.

FIG. 15 is a side view of an illustrative deformable controller with a position sensor such as an inertial measurement unit in accordance with an embodiment.

### DETAILED DESCRIPTION

Controllers may be provided that help users interact with content presented by electronic systems. As an example, a deformable controller may be provided that allows a user to move virtual objects in a three-dimensional world. The deformable controller may be used, for example, to translate objects in multiple dimensions and/or to rotate objects in three dimensions. The three-dimensional world may be presented to the user with electronic equipment such as a head-mounted device. Other types of devices may also be controlled based on user input gathered by a deformable controller, if desired.

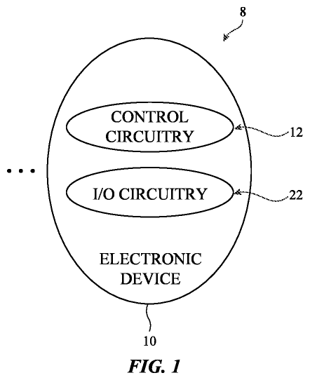

A schematic diagram of an illustrative system that produces content that may be manipulated using a controller is shown in FIG. 1. As shown in FIG. 1, system 8 may include one or more electronic devices such as electronic device 10. The electronic devices of system 8 may include tablet computers, laptop computers, desktop computers, cellular telephones, head-mounted devices, wristwatch devices, computer stylus devices, remote control devices, computer mice, accessories, speakers (e.g., ear speakers, desktop speakers, etc.), and/or other devices. The devices may be wearable devices, handheld devices, desktop devices, portable devices, and/or other devices. Deformable controllers may be incorporated into one or more of devices 10 and may include some or all of the circuitry of devices 10.

Devices 10 have control circuitry 12 for controlling the operation of devices 10 and supporting communications between devices 10. Devices 10 may also have input-output circuitry 22 for gathering input (e.g., user input and input from the environment) and for providing output such as visual output, audio output, and/or haptic output).

During use of system 8, one or more devices 10 may provide a user with content. The content may include visual content such as three-dimensional computer-generated content (e.g., visual content such as virtual reality content presented to a user with displays in a head-mounted device), audio content, haptic output, and/or other output. At the same time, one or more of these same devices 10 and/or other devices 10 in system 8 may use input-output circuitry 22 to gather user input that is used in interacting with the content. As an example, input-output circuitry 22 may gather user input that is used to make menu selections, move virtual objects in a three-dimensional world, adjust audio settings, draw items in a three-dimensional drawing program, play a three-dimensional video game, and/or otherwise interact with system 8. To facilitate these interactions, input-output circuitry 22 (and, if desired, control circuitry 12) may be used in forming controllers that help a user supply multidimensional input commands (e.g., commands involving translation in three dimensions and/or rotation in three dimensions) and other user input. The controllers may receive input from a user's finger. Flexible housings may be provided for the controllers, so these controllers may sometimes referred to as deformable controllers, three-dimensional controllers, three-dimensional deformable controllers, flexible controllers, etc.

Control circuitry 12 may include storage and processing circuitry for controlling the operation of device 10. Circuitry 12 may include storage such as hard disk drive storage, nonvolatile memory (e.g., electrically-programmable-read-only memory configured to form a solid-state drive), volatile memory (e.g., static or dynamic random-access-memory), etc. Processing circuitry in control circuitry 12 may be based on one or more microprocessors, microcontrollers, digital signal processors, baseband processors, power management units, audio chips, graphics processing units, application specific integrated circuits, and other integrated circuits. Software code may be stored on storage in circuitry 12 and run on processing circuitry in circuitry 12 to implement control operations for device 10 (e.g., data gathering operations, operations involving the adjustment of the components of device 10 using control signals, etc.). Control circuitry 12 may include wired and wireless communications circuitry. For example, control circuitry 12 may include radio-frequency transceiver circuitry such as cellular telephone transceiver circuitry, wireless local area network transceiver circuitry (e.g., WiFi® circuitry), millimeter wave transceiver circuitry, and/or other wireless communications circuitry.

During operation, the communications circuitry of the devices in system 8 (e.g., the communications circuitry of control circuitry 12 of devices 10), may be used to support communication between the electronic devices. For example, one electronic device may transmit video data, audio data, and/or other data to another electronic device in system 8. If desired, an electronic device may have a controller that gathers user input and this input may be used locally by that device and/or may be transmitted to another electronic device in system 8 (e.g., to control that remote device). Electronic devices in system 8 may use wired and/or wireless communications circuitry to communicate through one or more communications networks (e.g., the internet, local area networks, etc.). The communications circuitry may be used to allow data to be received by device 10 from external equipment (e.g., a tethered computer, a portable device such as a handheld device or laptop computer, online computing equipment such as a remote server or other remote computing equipment, or other electrical equipment) and/or to provide data to external equipment.

Devices 10 may include input-output devices in input-output circuitry 22. These input-output devices may be used to allow a user to provide devices 10 with user input. Input-output devices may also be used to gather information on the environment in which a device is operating. Output components in circuitry 22 may allow devices 10 to provide a user with output and may be used to communicate with external electrical equipment.

Input-output circuitry 22 may include sensor circuitry incorporated into one or more deformable controllers. Input-output circuitry 22 may also include one or more displays. In some configurations (e.g., when a device is a head-mounted device), the device includes left and right display devices. These displays devices may include scanning mirror display devices or other image projectors, liquid-crystal-on-silicon display devices, digital mirror devices, or other reflective display devices, left and right display panels based on light-emitting diode pixel arrays such as organic light-emitting display panels or display devices based on pixel arrays formed from crystalline semiconductor light-emitting diode dies, liquid crystal display panels, and/or or other left and right display devices that provide images to left and right eye boxes for viewing by the user's left and right eyes, respectively.

During operation, control circuitry 12 may use one or more display to provide visual content for a user of an electronic device (e.g., control circuitry 12 may provide displays in circuitry 22 with digital image data and/or may otherwise adjust displayed content). The content that is presented on the displays may sometimes be referred to as display image content, display images, computer-generated content, computer-generated images, virtual content, virtual images, or virtual objects.

Display images may be displayed in the absence of real-world content or may be combined with real-world images. In some configurations, real-world content may be captured by a camera (e.g., a forward-facing camera, sometimes referred to as a front-facing camera) so that computer-generated content may be electronically overlaid on portions of the real-world image (e.g., when a device is a pair of virtual reality goggles with an opaque display). In other configurations, an optical combining system may be used to allow computer-generated content to be optically overlaid on top of a real-world image.

Input-output circuitry 22 may include sensors such as sensor circuitry for deformable controllers and other sensors. The sensors may include, for example, three-dimensional sensors (e.g., three-dimensional image sensors such as structured light sensors that emit beams of light and that use two-dimensional digital image sensors to gather image data for three-dimensional images from light spots that are produced when a target is illuminated by the beams of light, binocular three-dimensional image sensors that gather three-dimensional images using two or more cameras in a binocular imaging arrangement, three-dimensional lidar sensors, three-dimensional radio-frequency sensors, or other sensors that gather three-dimensional image data), cameras (e.g., infrared and/or visible digital image sensors), gaze tracking sensors (e.g., a gaze tracking system based on an image sensor and, if desired, a light source that emits one or more beams of light that are tracked using the image sensor after reflecting from a user's eyes), strain gauges, touch sensors, capacitive proximity sensors, light-based (optical) proximity sensors, other proximity sensors, force sensors, sensors such as contact sensors based on switches, gas sensors, pressure sensors, moisture sensors, magnetic sensors, audio sensors (microphones), ambient light sensors, microphones for gathering voice commands and other audio input, sensors that are configured to gather information on motion, position, and/or orientation (e.g., accelerometers, gyroscopes, compasses, and/or inertial measurement units that include all of these sensors or a subset of one or two of these sensors), and/or other sensors. If desired, sensors such as these may be used in forming deformable controllers and may be fully or partially housed within a deformable controller housing.

To allow a user to control devices 10, user input and other information may be gathered using a deformable controller and/or other input devices associated with input-output circuitry 22. If desired, the deformable controller and/or other input-output devices in circuitry 22 may include devices such as haptic output devices (e.g., vibrating components), light-emitting diodes and other light sources, speakers such as ear speakers for producing audio output, circuits for receiving wireless power, circuits for transmitting power wirelessly to other devices, batteries and other energy storage devices (e.g., capacitors), joysticks, buttons, and/or other components.

Electronic devices 10 in system 8 may have housing structures (e.g., housing walls, straps, etc.). In configurations in which an electronic device 10 in system 8 is a head-mounted device (e.g., a pair of glasses, goggles, a helmet, a hat, etc.), the device may include head-mounted support structures (e.g., a helmet housing, a headband, temples and other glasses frame structures in a pair of eyeglasses, goggle housing structures, and/or other head-mounted structures). The head-mounted support structures may be configured to be worn on a head of a user during operation of the device and may support displays, sensors, other input-output devices in circuitry 22, and control circuitry 12.

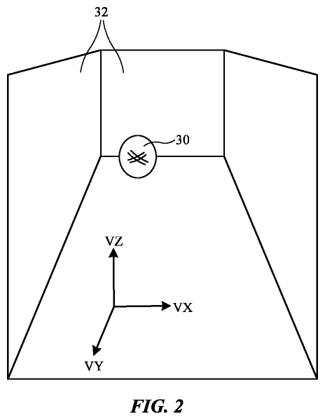

A deformable controller may be used to provide local and/or remote user input to any suitable electronic device 10 in system 8. Particularly in environments with rich content (e.g., three-dimensional computer-generated worlds being presented by head-mounted devices), it may be desirable for the deformable controller to gather multiple dimensions of user input (e.g., translation commands in X, Y, and Z dimensions, and/or rotation commands about X, Y, and/or Z axes). Consider, as an example, the illustrative three-dimensional virtual world of FIG. 2. As shown in this example, a head-mounted device or other output device 10 in system 8 may present a computer-generated representation of a three-dimensional world (e.g., a computer-generated visual environment having objects such as virtual object 30 and surfaces 32 that are rendered in three dimensions). As a user interacts with the computer-generated content that is being presented with the head-mounted device, the user may, among other things, desire to manipulate virtual objects. For example, the user may desire to move an object such as object 30 (e.g., to translate an object such as object 30 relative to three virtual reality world axes such as VX, VY, and or VZ axes and/or to rotate object 30 about axes VX, VY, and/or VZ). In this way, any arbitrary movement of object 30 may be achieved. In different software environments and/or hardware platforms, interactions such as these may perform different functions (e.g., object selection, menu item selection, object movement, cursor movement, the drawing of lines, cutting and paste operations, etc.). The use of input from a deformable controller to move objects is sometimes described herein as an example. In general, any suitable control operations in system 8 may be performed based on deformable controller input.

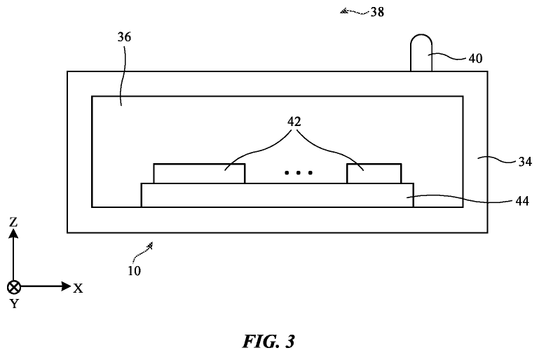

FIG. 3 is a cross-sectional side view of an illustrative electronic device 10 having a deformable controller. Device 10 may have housing walls 34 that help separate interior device regions such as interior region 36 from the exterior environment (exterior region 38) surrounding device 10. Deformable controller 40 may be located on a portion of device 10 that is accessible to the fingers of a user. In the example of FIG. 3, controller 40 has been mounted to the exterior of device 10 (e.g., on the surface of a support structure such as housing wall 34). As shown in FIG. 3, components 42 may be mounted in interior region 36 (e.g., on one or more printed circuits 44). Components 42 may include, for example, control circuitry 12, input output circuitry 22, and other circuitry in device 10 (see, e.g., FIG. 1).

Deformable controller 40 may have an elongated dome-shaped controller housing or other deformable housing that protrudes outwardly from the housing wall or other support structure on which deformable controller 40 is mounted. Controllers such as controller 40 of FIG. 3 may therefore sometimes be referred to as deformable controller protrusions, deformable protrusions, deformable nubs, flexible controllers, etc.

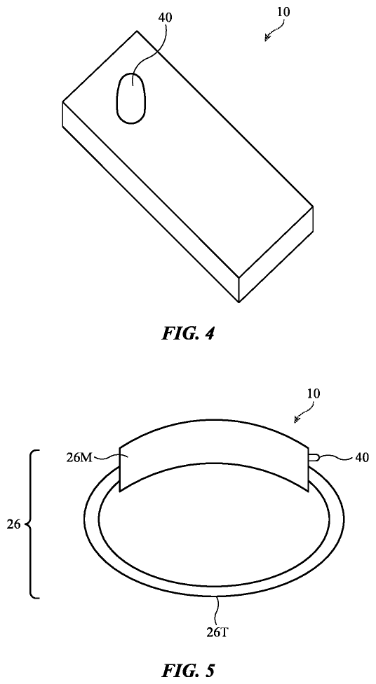

Illustrative electronic devices 10 that may be provided with one or more deformable controllers are shown in FIGS. 4 and 5. In the example of FIG. 4, device 10 is a handheld controller (e.g., a game controller, virtual-reality controller, remote control, and/or other small portable device with a housing configured to be held in a user's hand). In the example of FIG. 5, device 10 is a wearable device such as a head-mounted device. As shown in FIG. 5, electronic device 10 may include head-mounted support structure 26 to house the components of device 10 and to support device 10 on a user's head. Support structure 26 may include, for example, structures that form housing walls and other structures at the front of device 10 (e.g., sometimes referred to as a main unit or head-mounted device housing 26M) and additional structures such as headband 26T (or other straps, temples, or other supplemental supporting housing structures) that help to hold the main unit and the components in the main unit on a user's face so that the user's eyes are located within eye boxes where images are presented by the displays of device 10. In the example of FIG. 5, deformable controller 40 is located on a side of head-mounted device housing 26M (e.g., the right-hand side when device 10 is on a user's head). In this position on device 10, controller 40 may be readily located and reached by a user's fingers even when the user cannot see controller 40 because the user's eyes are coved with housing 26M. Controller 40 may also be used to control the operation of device 10 when device 10 is not being worn.

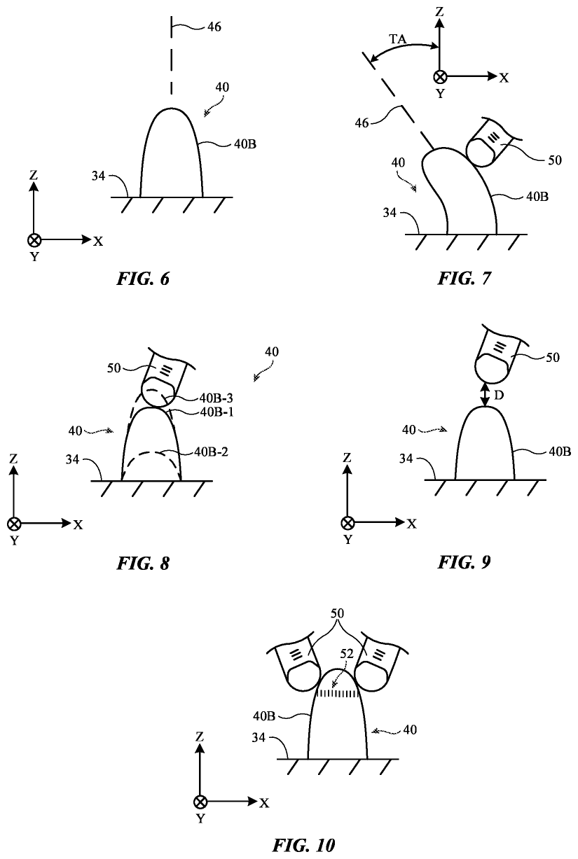

FIGS. 6, 7, 8, 9, and 10 are side views of deformable controller 40 showing how controller 40 may be manipulated by the fingers of a user to provide user input (sometimes referred to as finger input).

In the configuration of FIG. 6, controller 40 is in its nominal orientation (which is vertical in the illustrative arrangements of FIGS. 6, 7, 8, 9, and 10). Body 40B of controller 40 may be elongated along an axis such as longitudinal axis 46. In the example of FIG. 6, axis 46 is parallel to the Z axis. In general, controller 40 may be oriented in any direction in its nominal (unmanipulated) state.

To permit deformation by a user, body 40B may be formed from a soft elastomer (e.g., silicone, thermoplastic polyurethane, or other deformable polymer), may be formed from fabric, may be formed from deformable natural materials (e.g., leather), and/or may be formed from other flexible materials and/or combinations of these materials that can be bent and/or stretched by a user's fingers. The exterior surface of body 40B may be smooth and/or may have texture and/or protrusions to facilitate finger manipulation. In an illustrative configuration, which is sometimes described herein as an example, body 40B has the shape of an elongated dome (e.g., body 40B is rotationally symmetric around axis 46, is elongated, extends along longitudinal axis 46, and has a dome-shaped convex exterior surface characterized by compound curvature). This shape for body 40B allows a user to grip body 40B firmly, to slide one or more fingers along the surface of body 40B, to press against the surface of body 40B, and/or to otherwise interact with controller 40. Other shapes may be used for body 40B, if desired.

Controller 40 may be manipulated with a user's fingers and/or other body parts. Examples in which controller 40 is used to gather user finger input are described herein as an example. Controller 40 may include an array of capacitive electrodes that form a capacitive sensor and/or may include other sensor circuitry. This sensor circuitry may include sensor components that are used to detect touch. For example, the circuitry of controller 40 may use capacitive sensor measurements and/or other sensor measurements to gather single-finger touch input and/or multitouch input (e.g., touch commands involving contact between multiple fingers and the surface of controller 40). In multi-touch arrangements (sometimes referred to as multitouch gesture input arrangements) controller 40 may gather two-finger input and/or three-finger input. Taps, swipes, pinches, and/or other touch gestures may be gathered. If desired, the sensor components of controller 40 may gather force input (e.g., input related to the localized pressure and potentially localized inward deformation) on a particular location or locations on the surface of controller 40. Force input may be gathered in addition to touch input and/or in combination with touch input.

Another type of input that may be gathered by controller 40 (together with touch input and/or force input) relates to finger input or other input that causes controller 40 to tilt, twist, or otherwise deform. As shown in FIG. 7, for example, a user's finger (finger 50) may press to the side (e.g., horizontally to the left in the FIG. 7 example), thereby causing the tip of controller 40 to bend over and causing longitudinal axis 46 to tilt away (by a tilt angle TA) from the vertical (Z) axis due to deformation of body 40B. Body 40B may be tipped to the side in this way using manipulation from one or more fingers. The tilting of axis 46 may be used as a form of input (e.g., to tilt the axis of a corresponding virtual object) and this input may be combined with other input (e.g., touch gesture input), if desired.

As shown in FIG. 8, vertical input (input up and/or down the Z axis of FIG. 8) may be gathered when the user presses on the tip of body 40B. The “zero” location of the Z axis (e.g., the nominal unmanipulated location of a virtual object that is being moved) can correspond to position 40B-1 (halfway depressed), whereas more depressed conditions of body 40B (see, e.g., fully depressed controller body position 40B-2) may correspond to −Z movements (downward vertical input) and less depressed conditions of body 40B (see, e.g., fully undepressed controller body position 40B-3) may correspond to +Z movements (positive vertical input).

If desired, the sensors of controller 40 may gather finger input from finger(s) 50 at a distance. This type of arrangement is shown in FIG. 9, in which finger 50 is hovering at a non-zero distance D from the tip of controller body 40B. Controller 40 may measure distance D as a user moves finger 50 towards and/or away from controller 40. In this way, hover input (sometimes referred to as air gesture input or proximity input) may be gathered by controller 40 (e.g., to use at Z-dimension input). Capacitive proximity sensor components, optical proximity sensor components, and/or other proximity sensitive circuitry in the sensor circuitry of controller 40 may be used in gathering hover input.

FIG. 10 shows how body 40B may be provided with optional features 52 (e.g., knurling, texture, protrusions, and/or depressions, etc.) to help fingers 50 grip and/or otherwise manipulate body 40B. In general, any suitable type of input may be provided by fingers 50 and the sensor circuitry of controller 40 may gather and process this input to use in controlling system 8. Examples of input that may be gathered by controller 40 include twisting input (e.g., input in which features 52 are gripped firmly by a user while body 40B twists about the Z axis or a tilted axis such as tilted axis 46 of FIG. 7), bending input or other deforming input (see, e.g., the body tilt of FIG. 7, where the degree of bending may, if desired, form a type of input), pressing-type input (e.g., force input that compresses and/or releases body 40B from compression as described in connection with FIG. 8), proximity input such as hover input (see, e.g., FIG. 9, in which variations in distance D may serve as a type of input), touch input (e.g., potentially gentle input such as taps and/or swipes to the surfaces of body 40B, which may involve swipe moves upwards, downwards, around the periphery of body 40B, multi-finger pinch movements in which two or three fingers 50 pinch inwards and touch against opposing sides of body 40B while performing a rotational movement, up/down movement, and/or other touch input), force input, bending (body deformation input), etc. The examples of FIGS. 6, 7, 8, 9, and 10, which are illustrative, may be used individually and/or may be used in combination with each other and/or in combination with other types of controller input.

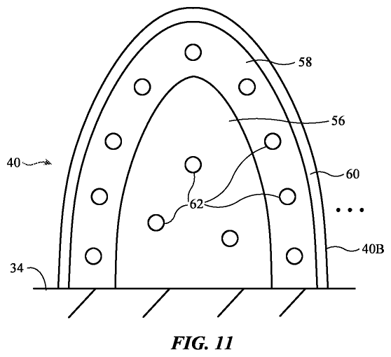

Controller 40 may be formed from one or more rigid materials and/or one or more softer materials (sometimes referred to as flexible materials, pliable materials, bendable materials, elastomeric materials, resilient materials, compressible materials, deformable materials, etc.) that allow body 40B to be deformed (pressed inwardly, bent, twisted, etc.). A cross-sectional side view of controller 40 in an illustrative configuration in which controller 40 is formed from one or more flexible materials is shown in FIG. 11. As shown in FIG. 11, body 40B may have the shape of a rounded protrusion formed from housing wall material 58. The interior of body 40B may be hollow (e.g., filled with air or other gas) or may be filed with material 56 (e.g., liquid, polymer foam, elastomeric material, and/or other flexible material). One or more optional covering layers 60 (e.g., coatings, molded elastomeric films, etc.) may be provided on the outer surface of housing wall 58.

Sensor structures for the sensor circuitry of controller 40 may be formed in any one or more of the housing walls, central filling portions, and/or coating layers of body 40B (see, e.g., illustrative sensor structures 62 of FIG. 11). These sensor structures may include electrodes, conductive traces such as metal traces, wires, printed circuits, packaged devices, and/or other sensor components and/or signal paths. The materials that make up controller body 40B (e.g., material 56, material 58, and/or material 60) may be formed from polymer (e.g., foam, elastomeric material such as silicon and/or thermoplastic polyurethane, and/or other polymer), fibers (e.g., polymer fibers, glass fibers, carbon fibers, metal fibers, etc.), fibers intertwined to form fabric (e.g., woven fabric, knit fabric, braided fabric, etc.), fibers embedded in polymer or other material, metal, glass, ceramic, leather or other natural materials, other materials, and/or combinations of these materials.

Sensor circuitry may be incorporated into controller 40 as illustrated by sensor structures 62 of FIG. 11. Any suitable sensor technology may be used in forming input sensors for controller 40 (e.g., acoustic technology, optical technology, electrical technology, magnetic technology, etc.). Output devices (e.g., haptic output devices formed from electromagnetic actuators, piezoelectric actuators, and/or other haptic devices), speakers, light-emitting diodes and other light-emitting devices, and/or other output circuitry may also be incorporated into controller 40 (e.g., at the locations of illustrative structures 62), if desired.

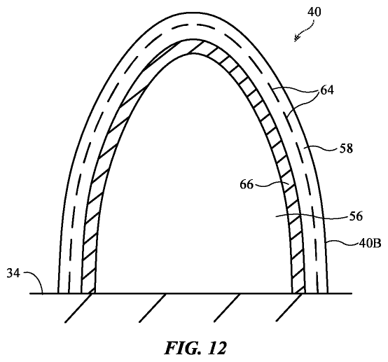

A cross-sectional side view of controller 40 in an illustrative configuration in which controller 40 has capacitive sensor circuitry is shown in FIG. 12. In the example of FIG. 12, body 40B has an inner member formed from material 56 coated with a ground conductor layer that forms ground electrode 66 (e.g., a metal coating that serves as a ground capacitor electrode). Metal traces are patterned to form individual capacitor electrodes 64, which (in the FIG. 12 example) are embedded in a housing wall structure formed from material 58. Capacitive sensor circuitry is coupled to electrodes 64 and 66 to make capacitive sensor measurements. Changes in the spacings between respective electrodes in controller 40 can be monitored by the capacitive sensor circuitry to gather user finger input (touch input, force input, proximity input, controller bending input, etc.). During operation, the capacitive sensor circuitry, which is electrically coupled to ground electrode 66 and electrodes 64, may make real time capacitance measurements that are indicative of the presence (and location) of each finger 50 that is touching or near to the exterior surface of controller 40 (e.g., an integrated circuit may make capacitance measurements and, if desired, digitize these measurements for processing by a microprocessor and/or other control circuitry). The capacitor sensor circuitry may also make sensor measurements on electrode 66 and electrodes 64 that serve as capacitive proximity sensor measurements (e.g., to measure hover distance D of FIG. 9), and/or that serve as force measurements (e.g., to measure housing deflection by measuring electrode capacitance changes due to changes in electrode gaps between adjacent electrodes such as changes in gaps is associated with electrode gap changes resulting from housing bending and other deformation).

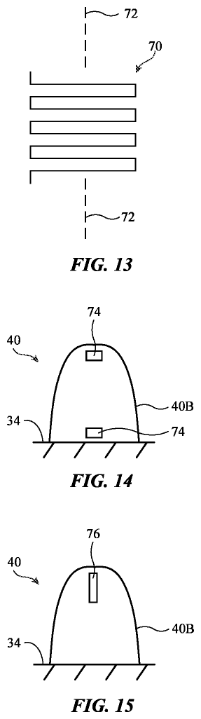

If desired, the walls of controller 40 (e.g., the inner surfaces of the wall formed from material 58, the outer surfaces of the protrusion formed from material 56, and/or other structure in controller 40) may be provided with strain gauges such as illustrative strain gauge 70 of FIG. 13. Strain gauge 70 may be formed from a meandering metal trace that is configured to exhibit a change in measured resistance when bent about an axis that runs perpendicular to the metal traces (see, e.g., illustrative bend axis 72 of FIG. 13). Controller 40 may have any suitable number of strain gauges 70 (e.g., at least 1, at least 2, at least 4, at least 8, at least 16, fewer than 100, etc.). When a user presses on the surface of controller 40 and thereby deforms that portions of controller 40 and/or when the user tilts and/or otherwise bends controller 40 as shown in the example of FIG. 7, the strain gauge(s) of controller 40 will detect the flexing of the housing walls and/or other structures forming controller 40.

As shown in the example of FIG. 14, controller 14 may have multiple components 74 that interact with each other to gather user input. Components 74 may, as an example, be mounted in respective upper and lower portions of body 40B. Components 74 may be optical components, electrical components, acoustic components, magnetic components, and/or other components for sensing input (e.g., finger input) to controller 40.

As an example, one of components 74 may be a light emitter and another of components 74 may be a light sensor that detects changes in emitted light from the light emitter that are indicative of user input (e.g., bending of body 40B, etc.). The detected changes may include changes in light intensity, changes in light direction, and/or other changes in the characteristics of the emitted light. The light emitter may be a light-emitting device such as a light-emitting diode, a laser diode, a lamp, etc. If desired, an illuminated target (e.g., a reference structure such as a reference mirror or fiducial) may be monitored by the light sensor instead of or in addition to using the light sensor to detect emitted light directly from the light emitter. The light sensor may be formed from a photodiode or other photodetector, an array of photodetectors, a camera (e.g., a visible image sensor and/or an infrared image sensor, etc.), and/or other light sensing circuitry.

As another example, one of components 74 may be a magnetic component such as a permanent magnet or an electromagnet that emits a magnetic field and another of components 74 may be a magnetic sensor that detects the emitted magnetic field. The magnetic sensor can detect changes in the orientation and strength of the emitted magnetic field and thereby gather user input (e.g., user input related to deformation of the flexible portions of body 40 and/or other input that changes the physical relationship (e.g., orientation, distance, etc.) between the magnetic component that emits the magnetic field and the magnetic sensor that detects the magnetic field.

If desired, one of components 74 may be an acoustic transducer (e.g., a tone generator, speaker, ultrasonic sound generator, etc.) that is configured to emit sound (e.g., a sound-emitting device) and another of components 74 may be a microphone or other acoustic sensor configured to detect the emitted sound. With this type of arrangement, user finger input (e.g., finger input that changes the acoustic properties of body 40B by creating localized damping, by bending body 40B, etc.) can be measured by analyzing the measured changes in the sound picked up by the microphone as the sound-emitting component emits sound. To avoid creating sound that is audible to users, the sound emitted by the sound-emitting device may be ultrasonic sound.

Sensor circuitry that uses capacitive measurements, resistance measurements, and/or other electrical measurements to detect finger input may also be provided in body 40B of controller 40 of FIG. 14. The use of controller 40 of FIG. 14 to make optical, acoustic, and/or magnetic measurements to gather user input is illustrative.

FIG. 15 shows how a position sensor such as position sensor 76 may be incorporated into controller 40 to gather user finger input (e.g., input that causes body 40B to bend, compress, and/or otherwise deform and change position and thereby move sensor 76 accordingly). Position sensor 76 may be an accelerometer, a magnetic sensor such as a compass, a gyroscope, and/or an inertial measurement unit that includes one or more of these position sensing devices. Position sensor 76 may measure position (e.g., location in X, Y, and Z), angular orientation, and/or changes in position and/or angular orientation over time (e.g., movement). Sensor 76 may therefore sometimes be referred to as a location sensor, orientation sensor, and/or motion sensor. In an illustrative configuration, sensor 76 is an inertial measurement unit and measures the position of body 40B to gather user finger input (e.g., sensor 76 can measure compression of body 40B, twisting of body 40B, and/or finger-induced angular tilt TA in body 40B including tilt direction and magnitude as described in connection with the movements of body 40B of FIGS. 7, 9, and 10). Other sensors (e.g., optical sensor circuitry, acoustic sensor circuitry, and/or magnetic sensor circuitry) may be used separately from position sensor 76 of FIG. 15 and/or in conjunction with sensor 76 of FIG. 15 (e.g., to improve accuracy). Strain gauges such as strain gauge 70 of FIG. 13 and/or capacitive sensors such as the capacitive sensor of FIG. 12 may also be included in body 40 and used with or without sensor 76 and/or optical, magnetic, and/or acoustic sensor circuitry, if desired.

In some embodiments, sensors may gather personal user information. To ensure that the privacy of users is preserved, all applicable privacy regulations should be met or exceeded and best practices for handling of personal user information should be followed. Users may be permitted to control the use of their personal information in accordance with their preferences.

In accordance with an embodiment, a controller is provided that includes an elongated flexible housing that extends along an axis, the elongated flexible housing is formed from a material that is configured to deform in response to finger input so that the elongated flexible housing bends away from the axis; and a sensor within the elongated flexible housing that is configured to measure the deformation.

In accordance with another embodiment, the sensor includes a plurality of capacitive sensor electrodes.

In accordance with another embodiment, the sensor includes a capacitive touch sensor.

In accordance with another embodiment, the sensor includes a multitouch capacitive touch sensor.

In accordance with another embodiment, the sensor includes capacitive sensor electrodes that measure deformation of the material as the elongated flexible housing bends away from the axis.

In accordance with another embodiment, the sensor includes a position sensor in the elongated flexible housing.

In accordance with another embodiment, the sensor includes a position sensor that measures bending of the elongated flexible housing away from the axis.

In accordance with another embodiment, the sensor includes an inertial measurement unit configured to detect bending of the elongated flexible housing away from the axis.

In accordance with another embodiment, the sensor includes a permanent magnet configured to emit a magnetic field and a magnetic sensor configured to measure the magnetic field to detect bending of the elongated flexible housing away from the axis.

In accordance with another embodiment, the sensor includes a light sensor that detects bending of the elongated flexible housing away from the axis.

In accordance with another embodiment, the sensor includes a light-emitting diode configured to emit light; and a photodetector configured to detect bending of the elongated flexible housing by measuring the emitted light.

In accordance with another embodiment, the sensor includes a force sensor that detects finger pressure on the elongated flexible housing.

In accordance with another embodiment, the sensor includes a touch sensor that detects touch input on the elongated flexible housing.

In accordance with another embodiment, the elongated flexible housing includes an elongated dome-shaped polymer structure.

In accordance with an embodiment, a head-mounted device is provided that includes a head-mounted housing having displays configured to display images; and a controller formed from a flexible nub that protrudes from the head-mounted housing, the flexible nub has an elongated dome-shaped flexible housing wall configured to receive finger input to control the displayed images.

In accordance with another embodiment, the controller includes a sensor in the flexible nub that gathers the finger input.

In accordance with another embodiment, the elongated dome-shaped flexible housing wall extends along an axis and the sensor detects deflection of the elongated dome-shaped flexible housing wall away from the axis.

In accordance with another embodiment, the sensor includes a multitouch touch sensor.

In accordance with another embodiment, the sensor includes a proximity sensor that detects finger hovering input that is provided from a distance away from the elongated dome-shaped flexible housing wall.

In accordance with another embodiment, the sensor includes a capacitive sensor with a plurality of capacitive sensor electrodes in the flexible nub.

In accordance with an embodiment, an electronic device is provided that includes an electronic device housing; a flexible nub that protrudes outwardly from the housing; and a sensor mounted in the flexible nub.

In accordance with another embodiment, the sensor includes a capacitive sensor that measures touch input to a surface of the flexible nub, force input associated with pressure against the flexible nub, and deformation input associated with bending of the flexible nub.

In accordance with another embodiment, the electronic device housing includes an electronic device housing selected from the group consisting of: a computer stylus housing, a head-mounted device housing, and a remote control housing.

The foregoing is merely illustrative and various modifications can be made to the described embodiments. The foregoing embodiments may be implemented individually or in any combination.

What is claimed is:

1. A controller, comprising:
an elongated flexible housing that extends along an axis, wherein the elongated flexible housing is formed from a material that is configured to deform in response to finger input so that the elongated flexible housing bends away from the axis; and
a sensor within the elongated flexible housing that is configured to measure the deformation.

2. The controller defined in claim 1 wherein the sensor comprises a plurality of capacitive sensor electrodes.

3. The controller defined in claim 2 wherein the sensor comprises a capacitive touch sensor.

4. The controller defined in claim 2 wherein the sensor comprises a multitouch capacitive touch sensor.

5. The controller defined in claim 1 wherein the sensor comprises capacitive sensor electrodes that measure deformation of the material as the elongated flexible housing bends away from the axis.

6. The controller defined in claim 1 wherein the sensor comprises a position sensor in the elongated flexible housing.

7. The controller defined in claim 1 wherein the sensor comprises a position sensor that measures bending of the elongated flexible housing away from the axis.

8. The controller defined in claim 1 wherein the sensor comprises an inertial measurement unit configured to detect bending of the elongated flexible housing away from the axis.

9. The controller defined in claim 1 wherein the sensor comprises a permanent magnet configured to emit a magnetic field and a magnetic sensor configured to measure the magnetic field to detect bending of the elongated flexible housing away from the axis.

10. The controller defined in claim 1 wherein the sensor comprises a light sensor that detects bending of the elongated flexible housing away from the axis.

11. The controller defined in claim 1 wherein the sensor comprises:
a light-emitting diode configured to emit light; and
a photodetector configured to detect bending of the elongated flexible housing by measuring the emitted light.

12. The controller defined in claim 1 wherein the sensor comprises a force sensor that detects finger pressure on the elongated flexible housing.

13. The controller defined in claim 1 wherein the sensor comprises a touch sensor that detects touch input on the elongated flexible housing.

14. The controller defined in claim 1 wherein the elongated flexible housing comprises an elongated dome-shaped polymer structure.

15. A head-mounted device, comprising:
a head-mounted housing having displays configured to display images; and
a controller formed from a flexible nub that protrudes from the head-mounted housing, wherein the flexible nub has an elongated dome-shaped flexible housing wall configured to receive finger input to control the displayed images.

16. The head-mounted device defined in claim 15 wherein the controller comprises a sensor in the flexible nub that gathers the finger input.

17. The head-mounted device defined in claim 16 wherein the elongated dome-shaped flexible housing wall extends along an axis and wherein the sensor detects deflection of the elongated dome-shaped flexible housing wall away from the axis.

18. The head-mounted device defined in claim 16 wherein the sensor comprises a multitouch touch sensor.

19. The head-mounted device defined in claim 16 wherein the sensor comprises a proximity sensor that detects finger hovering input that is provided from a distance away from the elongated dome-shaped flexible housing wall.

20. The head-mounted device defined in claim 16 wherein the sensor comprises a capacitive sensor with a plurality of capacitive sensor electrodes in the flexible nub.

21. An electronic device, comprising:
an electronic device housing;
a flexible nub that protrudes outwardly from the housing; and
a sensor mounted in the flexible nub.

22. The electronic device defined in claim 21 wherein the sensor comprises a capacitive sensor that measures touch input to a surface of the flexible nub, force input associated with pressure against the flexible nub, and deformation input associated with bending of the flexible nub.

23. The electronic device defined in claim 22 wherein the electronic device housing comprises an electronic device housing selected from the group consisting of: a computer stylus housing, a head-mounted device housing, and a remote control housing.
